(19) United States
(12) Patent Application Publication
(10) Pub. No.: US 2024/0384498 A1
(43) Pub. Date: Nov. 21, 2024

(54) PROGRAMMING CONTINUOUS EQUILIBRIUM MOTION IN MULTI-DOF SYSTEMS

(71) Applicant: THE REGENTS OF THE UNIVERSITY OF MICHIGAN, Ann Arbor, MI (US)

(72) Inventors: Maria REDOUTEY, Rochester, MI (US); Evgueni T. FILIPOV, Ann Arbor, MI (US)

(21) Appl. No.: 18/666,807

(22) Filed: May 16, 2024

Related U.S. Application Data
(60) Provisional application No. 63/467,429, filed on May 18, 2023.

(51) Int. Cl. E02F 3/36; F16F 1/14

(52) U.S. Cl. CPC E02F 3/3677; F16F 1/14

(57) ABSTRACT

A method of configuring a continuous equilibrium system includes providing a plurality of rigid members pivotally coupled together at a plurality of pivot joints and reconfigurable at least in response to gravity. Determining a potential energy of the plurality of rigid members as a result of gravity and calculating spring properties for springs located at one or more of the plurality of pivot joints to offset gravity that is operable to maintain a generally constant potential energy of the system irrespective of orientation in three-dimensional space. Springs are mounted to the plurality of rigid members according to the calculated spring properties.

### CROSS-REFERENCE TO RELATED APPLICATIONS

This application claims the benefit of U.S. Provisional Application No. 63/467,429, filed on May 18, 2023. The entire disclosure of the above application is incorporated herein by reference.

### GOVERNMENT INTEREST

This invention was made with government support under 1943723 awarded by the National Science Foundation. The government has certain rights in the invention.

### FIELD

The present disclosure relates to multiple degrees-of-freedom (DOF) systems and, more particularly, relates to methods and systems for programming, designing, and/or achieving continuous equilibrium motion in multi-DOF systems.

### BACKGROUND

This section provides background information related to the present disclosure which is not necessarily prior art. This section provides a general summary of the disclosure, and is not a comprehensive disclosure of its full scope or all of its features.

Reconfigurable structures are systems that undergo motion in order to achieve advanced functionality. Many reconfigurable structures, such as retractable roofs, robotic exoskeletons, and deployable bridges, have more than one degree of freedom (DOF) which allows for enhanced, sequential, and varied motions. However, designing such systems at a large scale is difficult because the effect of gravity is significant. Multi-DOF systems require complex controls to achieve desired motion paths and ensure stability; and their actuation requires large energy inputs to counteract gravity, often resulting in over-engineered designs. The present disclosure provides a method for transforming multi-DOF reconfigurable structures into systems with continuous equilibrium, allowing them to be unconditionally stable and reconfigured with a negligible input of energy.

The continuous equilibrium systems are achieved through the addition of springs with properties that are optimized to directly counteract gravity as the structure moves with respect to the different DOFs. The method can design a multi-DOF system to have continuous equilibrium throughout its entire kinematic space, or alternatively, to program specific continuous equilibrium paths so that the structure can move in a desired way while maintaining stability. The approach is demonstrated with different planar linkages and three-dimensional origami structures, and show that the principles are applicable to structures with any number of DOFs. The present disclosure furthers the ability of structural designers to create reconfigurable structures that are efficient to actuate, achieve desired motions, and remain stable under gravity.

Systems with multiple degrees of freedom (multi-DOF) are multi-functional structures with applications in a wide variety of fields. Multi-DOF structures have a range of motion associated with each DOF, which allow for drastic and functional change in the geometry, as seen when an excavator digs and transports material. Multiple DOFs can also allow for complex and varied motions, such as bipedal locomotion where humanoid robots can traverse both flat and uneven terrains. Another benefit of functional reconfiguration is the ability for a structure to be deployed from a compact state, as seen in space-saving furniture.

Multi-DOF systems can also be constructed by connecting individual one-DOF components into an integrated system, such as the adaptive facade on the Al-Bahar Towers. In addition, multi-DOF systems have been used as exoskeletons (D. Shi, W. Zhang, W. Zhang, and X. Ding, “A Review on Lower 354 Limb Rehabilitation Exoskeleton Robots,” Chinese Journal of Mechanical Engineering (English Edition), vol. 32, pp. 1-11, December 2019), robotic arms (S. Wu, Q. Ze, J. Dai, N. Udipi, G. H. Paulino, and R. Zhao, “Stretchable origami robotic arm with omnidirectional bending and twisting,” Proceedings of the National Academy of Sciences of the United States of America, vol. 118, no. 36, pp. 1-9, 2021), mechanical metamaterials (J. T. Overvelde, T. A. De Jong, Y. Shevchenko, S. A. Becerra, G. M. Whitesides, J. C. Weaver, C. Hoberman, and K. Bertoldi, “A three-dimensional actuated origami-inspired transformable metamaterial with multiple degrees of freedom,” Nature Communications, vol. 7, pp. 1-8, 2016), and in next-generation aircraft (S. Barbarino, O. Bilgen, R. M. Ajaj, M. I. Friswell, and D. J. Inman, “A Review of Morphing Aircraft,” Journal of Intelligent Material Systems and Structures, vol. 22, pp. 823-877, 2011).

From a technical perspective, while one-DOF systems have only one kinematic path, adding even a single other DOF results in a system with infinite paths for possible reconfiguration. As such, multi-DOF systems have a range of motion associated with each DOF and a kinematic space with dimension n for an n-DOF system. While multi-DOF reconfigurable structures offer enhanced motions and functionality, their implementation is hindered by two main challenges. First, the effect of gravity acting on these reconfigurable structures can result in destabilizing effects with unwanted motions (or even collapse), so counteracting gravity requires costly, complex, and inefficient actuation systems. Second, while infinite configurations are possible with multi-DOF systems, obtaining motion along a desired path or in a particular sequence is often difficult, requiring dedicated control to ensure motion and stability. The present disclosure addresses the above-mentioned challenges by exploring, designing for, and tailoring systems with continuous equilibrium.

Further areas of applicability will become apparent from the description provided herein. The description and specific examples in this summary are intended for purposes of illustration only and are not intended to limit the scope of the present disclosure.

### SUMMARY

The present disclosure uses springs with optimized properties to program stable configurations, stable paths, and sequential stable paths into multi-DOF structures by using the principle of continuous equilibrium. A structure in continuous equilibrium has a potential energy space that is nearly constant. This property results in a system that is perpetually stable and requires negligible energy to move from one configuration to another (T. Tarnai, “Zero stiffness elastic structures,” International Journal of Mechanical Sciences, vol. 45, no. 3, pp. 425-431, 2003), (M. Schenk and S. D. Guest, “On zero stiffness,” Proceedings of the Institution of Mechanical Engineers, Part C: Journal of Mechanical Engineering Science, vol. 228, no. 10, pp. 1701-1714, 2014), (S. Kok, G. Radaelli, A. Amoozandeh Nobaveh, and J. Herder, “Neutrally stable transition of a curved-crease planar shell structure,” Extreme Mechanics Letters, vol. 49, p. 101469, November 2021). Continuous equilibrium structures, including those with more than one degree of freedom, have been designed using springs (M. Schenk, S. D. Guest, and J. L. Herder, “Zero stiffness tensegrity structures,” International Journal of Solids and Structures, vol. 44, no. 20, pp. 6569-6583, 2007), (G. Chaudhary, S. G. Prasath, E. Soucy, and L. Mahadevan, “Totimorphic assemblies from neutrally-stable units,” Proceedings of the National Academy of Sciences of the United States of America, pp. 1-6, 2021), (Y. Li, “A method of designing a prescribed energy landscape for morphing structures,” International Journal of Solids and Structures, vol. 242, May 2022), pre-stress (S. D. Guest, E. Kebadze, and S. Pellegrino, “A zero-stiffness elastic shell structure,” Journal of Mechanics of Materials and Structures, vol. 6, no. 1-4, pp. 203-212, 2011), coupled deformations (G. Radaelli, “Reverse-twisting of helicoidal shells to obtain neutrally stable linkage mechanisms,” International Journal of Mechanical Sciences, vol. 202-203, 2021), and counterweights (V. Arakelian, J. P. L. Baron, and P. Mottu, “Torque minimisation of the 2-DOF serial manipulators based on minimum energy consideration and optimum mass redistribution,” Mechatronics, vol. 21, no. 1, pp. 310-314, 2011). However, most of these examples do not consider the effect of gravity. The present disclosure extends the present inventor's previous work on one-DOF systems (M. Redoutey and E. T. Filipov, “Designing continuous equilibrium structures that counteract gravity in any orientation,” Submitted, 2022) to multi-DOF reconfigurable structures and demonstrate how desired paths can be programmed as continuous equilibrium motions.

Programming motions into a reconfigurable structure allows certain paths to be favored and prohibits motion along unwanted directions. Programming can be achieved using discrete components, such as magnets and springs, or through continuous factors such as strain (J. Greenwood, A. Avila, L. Howell, and S. Magleby, “Conceptualizing stable states in origami-Based devices using an energy visualization approach,” Journal of Mechanical Design, Transactions of the ASME, vol. 142, no. 9, pp. 1-11, 2020). One type of motion path programming is self-assembly, which is often realized using origami-inspired designs (E. Hawkes, B. An, N. M. Benbernou, H. Tanaka, S. Kim, E. D. Demaine, D. Rus, and R. J. Wood, “Programmable matter by folding,” Proceedings of the National Academy of Sciences of the United States of America, vol. 107, no. 28, pp. 12441-12445, 2010), (M. T. Tolley, S. M. Felton, S. Miyashita, D. Aukes, D. Rus, and R. J. Wood, “Self-folding origami: Shape memory composites activated by uniform heating,” Smart Materials and Structures, vol. 23, no. 9, 2014), (T. van Manen, S. Janbaz, M. Ganjian, and A. A. Zadpoor, “Kirigami-enabled 396 self-folding origami,” Materials Today, vol. 32, pp. 59-67, February 2020).

At the microscale, residual stresses (T. G. Leong, B. R. Benson, E. K. Call, and D. H. Gracias, “Thin film stress driven self-folding of micro-structured containers,” Small, vol. 4, no. 10, pp. 1605-1609, 2008), (N. Bassik, G. M. Stern, and D. H. Gracias, “Microassembly based on hands free origami with bidirectional curvature,” Applied Physics Letters, vol. 95, no. 9, pp. 1-4, 2009), thermal and chemical stimuli (T. G. Leong, C. L. Randall, B. R. Benson, N. Bassik, G. M. Stern, and D. H. Gracias, “Tetherless thermobiochemically actuated microgrippers,” Proceedings of the National Academy of Sciences, vol. 106, no. 3, pp. 703-708, 2009), hydrogel swelling (J. H. Na, A. A. Evans, J. Bae, M. C. Chiappelli, C. D. Santangelo, R. J. Lang, T. C. Hull, and R. C. Hayward, “Programming reversibly self-folding origami with micropatterned photo-crosslinkable polymer trilayers,” Advanced Materials, vol. 27, no. 1, pp. 79-85, 2015), and Joule heating (Y. Zhu, M. Birla, K. R. Oldham, and E.T. Filipov, “Elastically and Plastically Foldable Electrothermal Micro-Origami for Controllable and Rapid Shape Morphing,” Advanced Functional Materials, vol. 2003741, pp. 1-10, 2020) combined with origami design principles have been shown to enable self-folding.

Motion paths can also be programmed into reconfigurable structures through purposeful self-contact (C. Coulais, A. Sabbadini, F. Vink, and M. van Hecke, “Multi-step self-guided pathways for shape-changing metamaterials,” Nature, vol. 561, no. 7724, pp. 512-515, 2018). In soft material systems, shape programming has been achieved using stimuli-responsive materials (Y. Mao, K. Yu, M. S. Isakov, J. Wu, M. L. Dunn, and H. Jerry Qi, “Sequential Self-Folding Structures by 3D Printed Digital Shape Memory Polymers,” Scientific Reports, vol. 5, pp. 1-12, 2015), (J. Zhang, Y. Guo, W. Hu, and M. Sitti, “Wirelessly Actuated Thermo- and Magneto-Responsive Soft Bimorph Materials with Programmable Shape-Morphing,” Advanced Materials, vol. 33, no. 30, 2021.), and compressive buckling (S. Xu, Z. Yan, K. I. Jang, W. Huang, H. Fu, J. Kim, Z. Wei, M. Flavin, J. McCracken, R. Wang, A. Badea, Y. Liu, D. Xiao, G. Zhou, J. Lee, H. U. Chung, H. Cheng, W. Ren, A. Banks, X. Li, U. Paik, R. G. Nuzzo, Y. Huang, Y. Zhang, and J. A. Rogers, “Assembly of micro/nanomaterials into complex, three-dimensional architectures by compressive buckling,” Science, vol. 347, no. 6218, pp. 154-159, 2015). The present disclosure focuses on designing multi-DOF systems to have specific continuous equilibrium motions, thus programming paths that the structure can move along effortlessly.

According to the principles of the present disclosure, a method of configuring a continuous equilibrium system includes providing a plurality of structural members pivotally coupled together at a plurality of pivot joints and reconfigurable at least in response to gravity. Determining a potential energy of the plurality of structural members as a result of gravity and calculating spring properties for springs located at one or more of the plurality of pivot joints to offset gravity that is operable to maintain a generally constant potential energy of the system irrespective of orientation in three-dimensional space. Springs are mounted to the one or more plurality of pivot joints according to the calculated spring properties.

According to a further aspect, the system is an excavator arm having a boom an arm and a bucket.

According to a further aspect, the springs include a first torsion spring connected between the arm and the bucket.

According to a further aspect, the springs include a second torsion spring connected between the boom and the arm.

According to a further aspect, the springs are torsion springs including a first torsion spring connected between the boom and an excavator body.

According to a further aspect, the system is a structure including a plurality of panels connected by rotational hinges.

According to a further aspect, the springs are torsion springs connected to adjacent panels about an axis of the respective hinges.

According to a further aspect, the system is a kirigami structure.

According to a further aspect, the kirigami structure includes a plurality of interconnected multi-panel cells.

According to a further aspect, the plurality of interconnected multi-panel cells each include a hexagonal panel and a plurality of trapezoidal panels.

According to a further aspect, the plurality of interconnected multi-panel sections are connected to adjacent multi-panel cells by a hinge.

According to a further aspect, each multi-panel cell includes a spring extending across the multi-panel cell.

According to a further aspect, a torsion spring on the hinge between adjacent multi-panel cells.

According to a further aspect, the plurality of interconnected multi-panel cells each include a top portion connected to an identical bottom portion at perimeter edges thereof.

According to a further aspect, the system is an arm structure of an industrial device.

According to a further aspect, the system is a panel system of an architectural device.

According to a further aspect, the system is a mechanical arm having multiple sections and an actuator connected between adjacent arm sections.

According to a further aspect, the actuator is one of a hydraulic, pneumatic, servo-electric and electro-mechanical actuator.

### BRIEF DESCRIPTION OF THE DRAWINGS

FIG. 1A schematically illustrates optimizing a one-DOF Watt's linkage for continuous equilibrium by adding internal torsional springs at locations A, B, C and D of the one-DOF Watt's linkage having kinematics defined by ϕ₁ and resulting in a nearly flat PE_{T} curve. The potential energy due to gravity (PE_{G}) is plotted in gray.

FIG. 1B schematically illustrates optimizing a two-DOF Watt's linkage for continuous equilibrium by adding five internal torsional springs to the two-DOF Watt's linkage having kinematics defined by ϕ₁ and ϕ₂ results in minimizing the fluctuation in the PE_{T} surface by 98.5% when compared to the PE_{G} surface (contour line interval=2 N-m). Cross-sections of the PE_{T} surface show nearly flat potential energy curves.

FIG. 1C schematically illustrates optimizing for continuous equilibrium a three-DOF Watt's linkage defined by angles ϕ₁, ϕ₂ and ϕ₃. The potential energy is visualized as a volume (contour line interval=2 N-m). Taking cross sections of the volume shows that the PE_{T} surfaces at the cross-sections are nearly flat (contour line interval 2=N-m). Cross-sections of the PE_{T} surfaces show nearly flat potential energy curves;

FIG. 2A illustrates designing the two-DOF Watt's linkage to have different stable paths. To program a stable path along ϕ₂=90°, five internal torsional springs are added. Along the path, the fluctuation in potential energy has been reduced by 99.7% compared to the case without springs (contour line interval=5 N-m). Perpendicular to the path, the potential energy has a valley centered on ϕ₂=90°. The gradient of the potential energy is aligned with the desired gradient field ∇_{d}.

FIG. 2B illustrates a stable path along the line ϕ₂=300°−ϕ₁ (contour line interval=1 N-m). The fluctuation in potential energy is reduced by 98.9% along the path. The potential energy valley is shallow, but the gradient of the potential energy is aligned with the desired gradient field ∇_{d}.

FIG. 2C illustrates for a curved path along ϕ₂=(210°−ϕ₁)²+86°, we add two identical extensional springs to the linkage. For this case, the fluctuation in potential energy along the path is reduced by 99.5% (contour line interval=1 N-m).

FIG. 2D illustrates designing the two-DOF Watt's linkage to have two sequential stable paths, one along ϕ₁=180° and one along ϕ₂=90°. The paths are placed into potential energy valleys by splitting ∇_{d} into four regions. Along the paths, the fluctuation is reduced by 93% (contour line interval=1 N-m);

FIG. 3A illustrates adding stable configurations to stable paths. (A) Stable configuration at ϕ₁=210°, ϕ₂=90°, along the path ϕ₂=90° (contour line interval=2 N-m). FIG. 3B illustrates a stable configuration at ϕ_1=190°, ϕ₂=110°, along the path ϕ₂=300°−ϕ₁ (contour line interval=1 N-m);

FIG. 4A illustrates designing a two-DOF excavator to have a continuous equilibrium path. The excavator is modeled using rigid links with kinematics defined with ϕ₁ and ϕ₂. Internal torsional, external torsional, internal extensional, and external extensional springs are added to the system and their properties are optimized to achieve continuous equilibrium.

FIG. 4B illustrates the total potential energy PE_{T} has a shallow valley along the desired path. The fluctuation in PE_{T} along the path is reduced by 66% (contour line interval=10 kN-m).

FIG. 4C illustrates the gradient field ∇_{d} represents the constraint applied to the optimization problem to ensure the stability of the path. The gradient of PET is aligned with ∇_{d}, especially for small ϕ₁ and large ϕ₂;

FIG. 5 is a schematic view of an excavator showing dimensions and applied masses;

FIG. 6A illustrates designing a five-fold origami vertex to have continuous equilibrium. Four internal torsional springs A, B, C, and D are placed on the crease lines of the origami vertex.

FIG. 6B illustrates the five-fold origami vertex has two degrees of freedom, defined by ϕ₁ and ϕ₂. The kinematic space is limited due to panel contact and the boundary is illustrated here.

FIG. 6C illustrates adding the four optimized springs minimizes the fluctuation in total potential energy by 90%, resulting in a nearly flat PE_{T} surface (contour line interval=1 N-m);

FIG. 7A illustrates a pop-up kirigami dome has two DOFs: an assembly motion, defined by ϕ₁, and a dome-forming motion, defined by ϕ₂.

FIG. 7B illustrates two sets of extensional springs are added within each hexagonal cell and one set of torsional springs connects the cells.

FIG. 7C The first path is moving to a stable state at ϕ₁=100°, where the cells are fully closed. The second path is designed to have continuous equilibrium, where ϕ₂ increases to 20° (contour line interval=100 N-m).

FIG. 7D illustrates potential energy of the structure along the paths. At the end of path 1, there is a local minimum in potential energy, indicating a stable state. Along path two, the fluctuation in potential energy is reduced by 95.7%; and

FIG. 8 is a schematic view of the panels used in the pop-up kirigami dome and spring labels.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Section 1 below describes the design method for creating multi-DOF structures with continuous equilibrium. Section 2 focuses on designing structures with programmed continuous equilibrium states, such as stable configurations and paths. Section 2 gives examples of how the design method can be expanded to practical and more complex structures. Section 4 provides a discussion of the calculation methods.

### 1. Designing a Multi-DOF Planar Linkage for Continuous Equilibrium

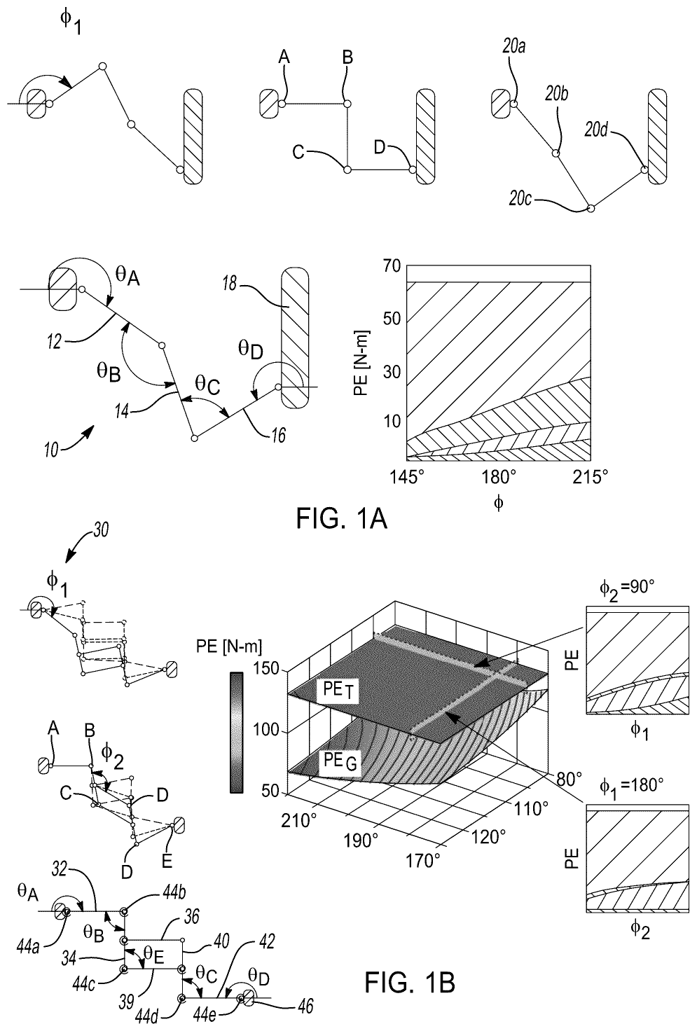

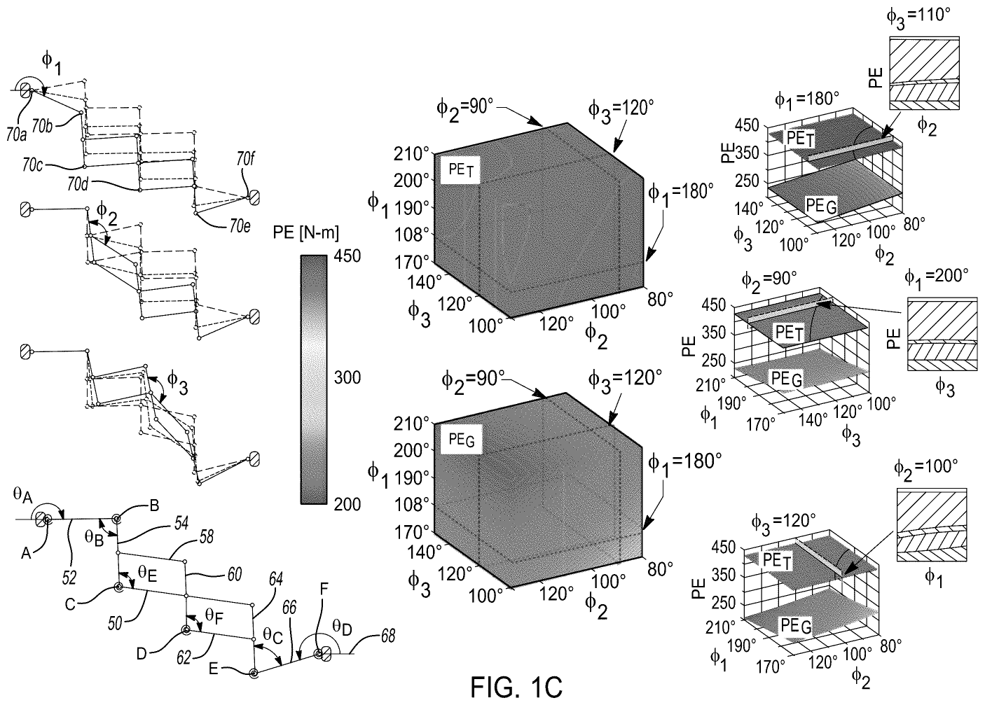

This section illustrates how springs can be designed and added to a multi-DOF linkage to convert it into a system that counteracts gravity. Design variations of the Watt's linkage (FIG. 1) are provided such that they will have continuous equilibrium by adding torsional springs that counteract the effect of gravity.

With reference to FIG. 1, the optimization of the one-, two-, and three-DOF Watt's linkage for continuous equilibrium is illustrated. In FIG. 1A, The one-DOF Watt's linkage has kinematics defined by ϕ₁. Adding internal torsional springs at locations A, B, C, and D results in a nearly flat PE_{T} curve. The potential energy due to gravity (PEG) is plotted in gray. With reference to FIG. 1B, the two-DOF Watt's linkage has kinematics defined by ϕ₁ and ϕ₂. Adding five internal torsional springs minimizes the fluctuation in the PE_{T} surface by 98.5% when compared to the PE_{G} surface (contour line interval=2 N-m). Cross-sections of the PE_{T} surface show nearly flat potential energy curves. With reference to FIG. 1C, the three-DOF Watt's linkage is defined by angles ϕ₁, ϕ₂, and ϕ₃. The potential energy is visualized as a volume (contour line interval=2 N-m). Taking cross sections of the volume shows that the PE_{T} surfaces at the cross-sections are nearly flat (contour line interval 2=N-m). Cross-sections of the PE_{T} surfaces show nearly flat potential energy curves.

We assume the structure is a planar linkage made of rigid bars and rotational joints. For an n-DOF system, the kinematics are defined by independent parameters ϕ₁, . . . , ϕₙ. The potential energy due to gravity for a planar system with B bars is

$${PE}_{G} ( {ϕ}_{1} , … , {ϕ}_{n} ) = {\sum }_{b}^{B} {m}_{b} * {L}_{b} * g * {h}_{b} ( {ϕ}_{1} , … , {ϕ}_{n} ) , \qquad ( 1 )$$

where m_{b} is the uniform mass distribution (units: N/m), L_{b} is the bar length, g=9.81 m/s², and h_{b} is the height of the center of mass of bar b. For the Watt's linkage examples, we assume that all bars have a length of 1 m and a uniform mass distribution of 1 kg/m.

We use optimization to compute the torsional spring properties (rest angle and stiffness) that counteract gravity most effectively. The potential energy in a torsional spring depends on one or more of the degrees of freedom (ϕ₁, . . . , ϕₙ for an n-DOF system); as the configuration of the structure changes, each spring will move towards or away from its rest position and will release or store energy. In a system with S torsional springs, the potential energy stored in the springs is

$${PE}_{S} ( {ϕ}_{1} , … , {ϕ}_{n} ) = {\sum }_{s}^{S} \frac{1}{2} {{k}_{s} ( {θ}_{s} ( {ϕ}_{1} , … , {ϕ}_{n} ) - {α}_{s} )}^{2} \text{?} \qquad ( 2 )$$

$$\text{?} \text{indicates text missing or illegible when filed}$$

where kₛ is the linear stiffness (units: N-m/rad), θₛ is the kinematic angle of the spring (which can be a function of one or more of the DOFs, depending on the system kinematics), and αₛ is the rest angle of the spring, where the stored potential energy is zero. The total potential energy of the system of bars and springs is

$${PE}_{T} ( {ϕ}_{1} , … , {ϕ}_{n} ) = {PE}_{S} ( {ϕ}_{1} , … , {ϕ}_{n} ) + {PE}_{G} ( {ϕ}_{1} , … , {ϕ}_{n} ) . \qquad ( 3 )$$

### 1.1. Optimization Setup

A system with continuous equilibrium has nearly constant potential energy. To formulate an objective function for the design problem, the fluctuation in total potential energy (PE_{T}) of the system is minimized across the entire kinematic space. A root-mean-square deviation (RMSD) is used to quantify the fluctuation in potential energy. The fluctuation is defined as:

$$\sqrt{\frac{\sum {( {PE}_{T} - mean ( {PE}_{T} ) )}^{2}}{N} ,} \qquad ( 4 )$$

where N is the number of points used to sample PE_{T}. With adequate discretization in sampling, the normalized sum in Equation 4 is equivalent to the integral over the entire PE_{T} space, regardless of the dimension. Thus, this formulation is applicable to any n-DOF system. The bounds placed on the design variables ensure that the stiffness of each spring is positive (kₛ≥0) and restricts the rest angle of a torsional spring to the interval [0, 2π]. There are no additional constraints placed on the optimization problem to obtain continuous equilibrium, which is defined as:

$$min ( \sqrt{\frac{\sum {( {PE}_{T} - mean ( {PE}_{T} ) )}^{2}}{N}} ) \qquad ( 5 )$$

$$s . t . {k}_{s} \geq 0 \qquad ( 6 )$$

$$∝ ϵ [ 0 , 2 π ] . \qquad ( 7 )$$

### 1.2 One-DOF Watt's Linkage

The system kinematics of the one-DOF Watt's linkage 10 are defined by the angle ϕ₁ (FIG. 1(A)). The linkage 10 as shown includes links 12, 14, 16 connected to a base 18. The fluctuation in potential energy due to gravity (plotted in gray) is equal to 6.8 N-m. To achieve continuous equilibrium, we add four internal torsional springs 20a-20d at locations A, B, C, and D. The optimization problem given in Equation 5 is used to compute the spring properties (kₛ, αₛ) that minimize the fluctuation in PE_{T}. Adding the four springs 20a-20d results in a fluctuation of 0.0021 N-m, a 99.97% reduction from the fluctuation without springs. The resulting PE_{T} curve is nearly flat, indicating that the system is in continuous equilibrium. The spring properties for the one-DOF Watt's linkage are given in Section 4 below.

### 1.3 Two-DOF Watt's Linkage

The two-DOF Watt's linkage 20 has kinematics defined by the independent angles ϕ₁ and ϕ₂. The potential energy due to gravity varies with both DOFs and can be visualized as a two-dimensional surface (FIG. 1B). The linkage 30 shown includes six linkages 32, 34, 36, 38, 40, 42 connected to a base 46, as shown. To achieve continuous equilibrium, we add five internal torsional springs 44a-44e at locations A, B, C, D, and E. The total potential energy of the system is written as

$$( 8 )$$

$${PE}_{T} ( {ϕ}_{1} , {ϕ}_{2} ) = \frac{1}{2} {k}_{A} ( \text{} {{θ}_{A} ( {ϕ}_{1} , - {α}_{A} )}^{2} + \frac{1}{2} {k}_{B} {( {θ}_{B} ( {ϕ}_{1} , {ϕ}_{2} ) - {α}_{B} )}^{2} +$$

$$\frac{1}{2} {k}_{C} {( {θ}_{C} ( {ϕ}_{1} , {ϕ}_{2} ) - {α}_{C} )}^{2} + \frac{1}{2} {{k}_{D} ( {θ}_{D} ( {ϕ}_{1} , {ϕ}_{2} ) - {α}_{D} )}^{2} +$$

$${\frac{1}{2} {k}_{E} ( {θ}_{E} , {ϕ}_{2} ) - {α}_{E} )}^{2} + {PE}_{C} ( {ϕ}_{1} , {ϕ}_{2} ) .$$

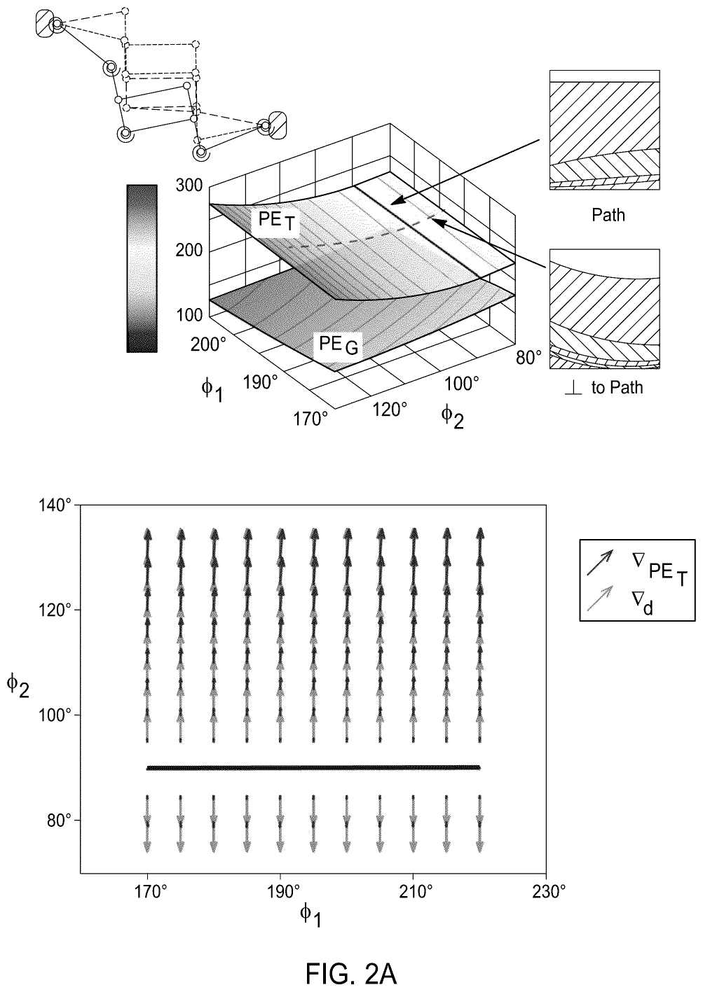

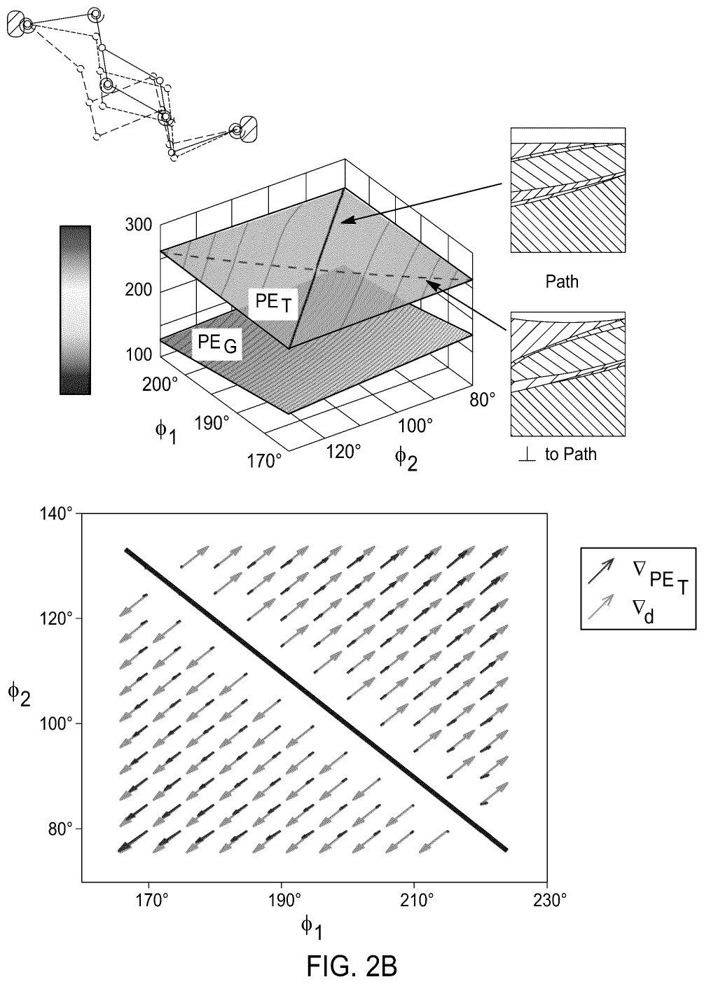

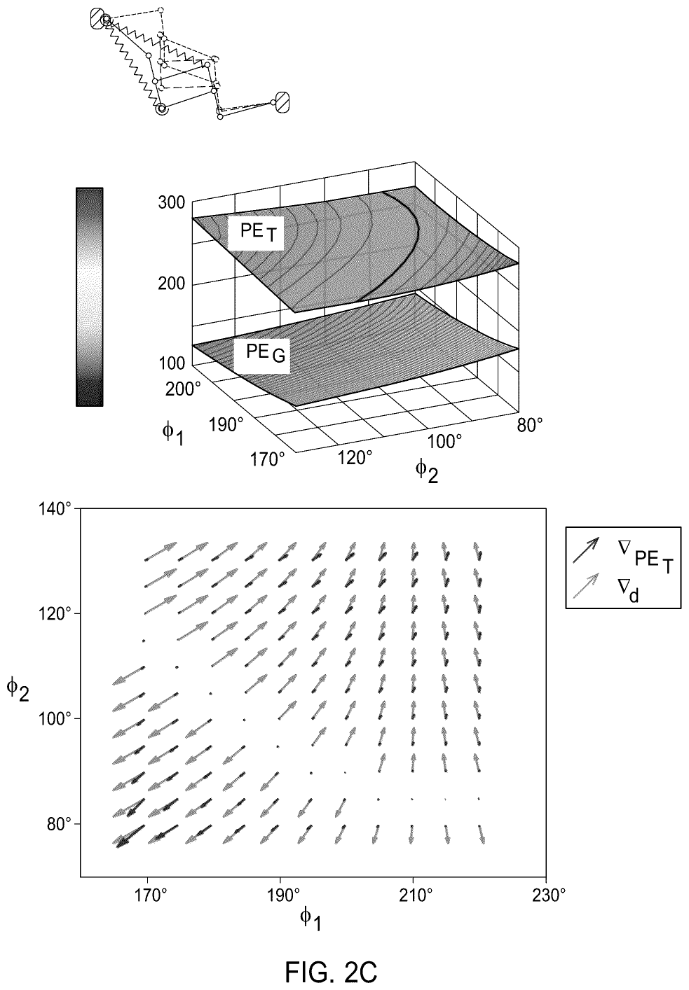

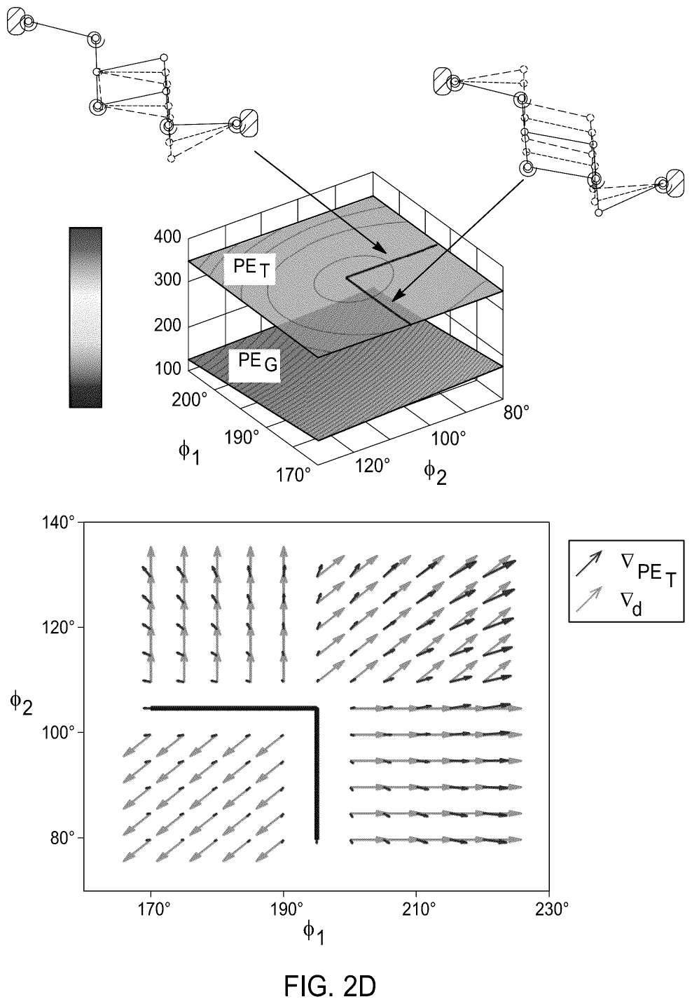

Springs 44b, 44c, and 44d have kinematics that depend on both DOFs, while spring 44a only depends on ϕ₁ and spring 44e only depends on ϕ₂. Using Equation 5, the spring properties that will counteract gravity are computed and result in continuous equilibrium throughout the entire two-dimensional potential energy space. With the springs 44a-44e, the fluctuation in PE_{T} is reduced by 98.5% from 11.6 N-m to 0.18 N-m, resulting in a nearly flat surface. Two cross-sections of the PE_{T} surface are shown in FIG. 2B for ϕ₁=180° and ϕ₂=90°. Along the cross-section where ϕ₁=180° 118, the fluctuation in PE_{T} is reduced by 96.8% from 5.24 N-m to 0.17 N-m. For ϕ₂=90°, the fluctuation is reduced by 98.6% from 10.96 N-m to 0.16 N-m. The optimized spring stiffnesses and rest angles for the two-DOF Watt's linkage 30 are given in Section 4 below.

### 1.4 Three-DOF Watt's Linkage

The three-DOF Watt's linkage 50 has kinematics defined by three independent angles, ϕ₁, ϕ₂ and ϕ₃ (FIG. 1 (C)). The potential energy due to gravity PE_{G} depends on all three DOFs and is visualized as a volume. The linkage 50 includes linkages 52, 54, 56, 58, 60, 62, 64, 66 attached to a base 68, as shown. To achieve continuous equilibrium, we add internal torsional springs 70a-70f at locations A, B, C, D, E, and F and optimize their properties. Springs 70b, 70c, and 70d depend on all three DOFs, while spring 70a depends only on ϕ₁, spring 70e depends only on ϕ₂, and spring 70f only depends on ϕ₃. The fluctuation in PET throughout the entire volume is reduced by 94.2%, from 18.1 N-m to 1.06 N-m with the addition of optimized springs. Three cross-sections of the potential energy volume are shown in FIG. 1C, showing that the potential energy surfaces corresponding to ϕ₁=180°, ϕ₂=90°, and ϕ₃=120° 129 are nearly flat; the fluctuation in PE_{T} is reduced across the surfaces by 91.9%, 95.4%, and 96.5%, respectively. Extracting further, cross-sections of the surfaces illustrate that the PE_{T} curves are nearly flat for several combinations 131 of ϕ₁, ϕ₂, and ϕ₃. For the cross-section where ϕ₁=180°, ϕ₃=110° (where ϕ₂ varies), the fluctuation in PET is reduced from 11.4 N-m to 1.3 N-m; for ϕ₃=120°, ϕ₂=100°, it is reduced from 26 N-m to 0.33 N-m. However, for the case where ϕ₂=90°, ϕ₁=200°, the fluctuation increases from 1.04 N-m to 1.44 N-m. Along this path, the potential energy due to gravity is nearly constant, meaning that the linkage is already counterbalanced simply based on the bar masses and the geometry of the structure. The optimized spring properties for the three-DOF Watt's linkage 50 are given in Section 4.

### 2. Programming Continuous Equilibrium Motions

Programming specific motions into a reconfigurable structure allows certain paths to be favored and prohibits motion in unwanted directions. Programming a continuous equilibrium motion would allow a highly flexible system with many DOFs to navigate effortlessly along a desired path without requiring external forces to keep it on the path. A similar approach is used as described in Section 1 to design systems that, with the addition of springs with optimized properties, follow a programmed continuous equilibrium motion under gravity.

In this section, the addition of springs with optimized properties to the two-DOF Watt's linkage are demonstrated to program a stable, continuous equilibrium path. Next, additional springs are shown to be used to program a stable configuration along a path. Finally, sequential continuous equilibrium paths can be programmed. The optimized spring properties for all examples in this section are provided in Section 4.

### 2.1. Programming a Stable Path

The objective for designing the two-DOF Watt's linkage with a stable path is to minimize the fluctuation of the PE_{T} along the path, formulated as:

$$min ( \sqrt{\frac{\sum {( {PE}_{{T}_{path}} - mean ( {PE}_{{T}_{path}} ) )}^{2}}{{N}_{path}}} ) \qquad ( 9 )$$

$$s . t . {k}_{s} \geq 0$$

$${α}_{s} ϵ [ 0 , 2 π ] .$$

where Nₚₐₜₕ is the number of sampling points along the path. Using this objective function, the path is designed to have continuous equilibrium, but the stability of the path is not enforced. For example, a system could be designed to have a perfectly flat path, but a small perturbation moving the system off of the path would lead to collapse. In order to ensure that the programmed continuous equilibrium path is stable, we implement additional constraints to the optimization problem.

To be stable, the desired path must be a global potential energy minimum (valley in two-dimensional space); the gradient of the potential energy (∇PE_{T}) must be orthogonal to the path (Y. Li and S. Pellegrino, “A Theory for the Design of Multi-Stable Morphing Structures,” Journal of the Mechanics and Physics of Solids, vol. 136, 2020). To ensure a stable path, we use constraints to align ∇PE_{T} with a desired gradient field, denoted as ∇_{d}. For a two-DOF system with a given path defined as ϕ₂=f(ϕ₁), where [u, v] is the tangent vector to the path, ∇_{d} is formulated as

$${∇}_{d} = \{ \begin{matrix}[ υ , - u ] & {ϕ}_{2} < f ( {ϕ}_{1} ) \\ [ - υ , u ] & {ϕ}_{2} > f ( {ϕ}_{1} ) ,\end{matrix} \qquad ( 10 )$$

describing the gradient field pointing orthogonal to the path. Once we have established ∇d, we can compute the angle between it and ∇PE_{T} across the entire PE_{T} space. The constraint requires the angle to be smaller than some positive value δ. The constraint is formulated as

$${cos}^{- 1} ( ∇ {PE}_{T} \cdot {∇}_{d} ) - δ \leq 0 , \qquad ( 11 )$$

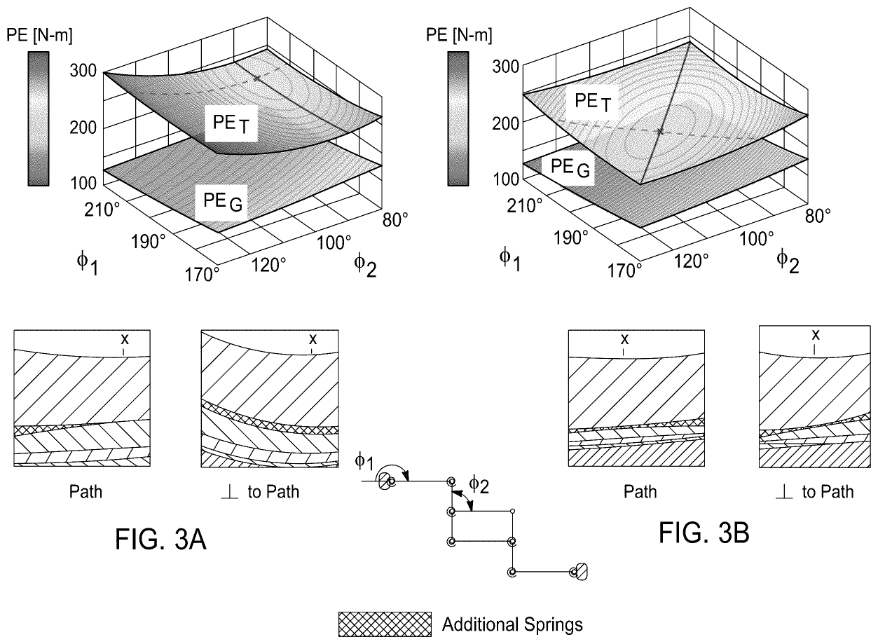

and is applied to all sampled points in the kinematic design space. If ∇PE_{T} is perfectly aligned with ∇_{d}, then the angle between them is zero, the constraint is satisfied, and the path is stable. The results presented in FIG. 3 use a tolerance of δ=π/2, meaning that the PE_{T} vector will point anywhere from orthogonal to the path (the ideal case) to parallel to the path. Further improvements to the optimization method could likely allow for smaller values of δ to be used in the constraint and thus provide a stricter assurance of path stability. Nevertheless, the results illustrate good agreement between ∇PE_{T} and ∇_{d} despite the large δ used. Equations 10 and 11 are presented here for a two-DOF system and could be extended for higher-DOF systems in the future.

Using the objective function given in Equation 9 and the constraint in Equation 11, we designed the two-DOF Watt's linkage to have a stable path at ϕ₂=90° (FIG. 2A). The desired gradient field ∇_{d} is written as

$${∇}_{d} = \{ \begin{matrix}[ 0 , - 1 ] , & {ϕ}_{2} < 90 ° \\ [ 0 , 1 ] , & {ϕ}_{2} > 90 ° ,\end{matrix} \qquad ( 12 )$$

to enforce the stability of the path. The fluctuation in potential energy along the path is reduced by 99.7% compared to the system without springs. Comparing the plots of ∇PE_{T} and ∇_{d} shows that these vectors are aligned, and there is a global potential energy valley along the path where ϕ₂=90° . If the system experiences a small perturbation, it will naturally return to the path along ϕ₂=90°. For a path where ϕ₂=300° 180−ϕ₁ (FIG. 2B), ∇_{d} is defined as:

$${∇}_{d} = \{ \begin{matrix}[ - 1 , - 1 ] , & {ϕ}_{2} < 300 ° - {ϕ}_{1} \\ [ 1 , 1 ] , & {ϕ}_{2} > 300 ° - {ϕ}_{1}\end{matrix} \qquad ( 13 )$$

With springs, the potential energy is reduced by 98.9% along the path and there is a PE_{T} valley centered on the path. For this path, the valley is less pronounced than the previous example, but the stability of the path is still ensured due to the alignment of ∇PE_{T} and ∇_{d}. In addition to linear paths, we can design a curved path to have continuous equilibrium (FIG. 2C). The equation of the path is ϕ₂=(212°−ϕ₁)²+86°. The tangent vector [u, v] is thus equal to [1, 2u-424°] and ∇_{d} is defined as

$${∇}_{d} = \{ \begin{matrix}[ 2 {ϕ}_{1} - 424 ° , - 1 ] , & {ϕ}_{2} < {( 212 ° - {ϕ}_{1} )}^{2} + 86 ° \\ [ - 2 {ϕ}_{1} + 424 ° , 1 ] , & {ϕ}_{2} > {( 212 ° - {ϕ}_{1} )}^{2} + 86 °\end{matrix} \qquad ( 14 )$$

For this example, two identical extensional springs are placed on the two-DOF Watt's linkage (FIG. 2 (C)) in addition to two torsional springs and used the optimization method to compute their properties. The potential energy in an extensional spring x is

$${PE}_{x} = \frac{1}{2} {k}_{x} {( {L}_{x} - {L}_{0 x} )}^{2} ,$$

where kₓ is the spring stiffness (units: N/m), Lₓ is the deformed length of the spring, and L₀ₓ is the rest length, where the energy stored in the spring equals zero. With the extensional springs, the fluctuation in potential energy is reduced by 99.5% along the curved path, and the path is placed in a global PE_{T} valley. The gradient plot shows good agreement between ∇PE_{T} and ∇_{d}.

### 2.2. Programming a Stable Configuration Using Superposition

For certain applications, it may be beneficial to add a stable configuration to a system that has already been designed to have a stable continuous equilibrium path. For one-DOF systems, constraints can be used to create one or more stable states at target configurations, and a similar approach could be adapted to design multi-stable states in the multi-DOF systems. Here, a method is shown for adding one stable configuration to a multi-DOF system using superposition. To add a stable configuration, we implement an additional set of springs and set their rest angles to be equal to their kinematic angle in the desired configuration. The potential energy contribution of the additional set of springs is then superimposed with the potential energy due to gravity and the original optimized springs, resulting in a PE_{T} surface with a stable path and a stable configuration along that path. The stiffness of the additional springs affects how steeply PE_{T} increases when moving away from the stable configuration; high stiffness results in a steeper gradient. We designed the two-DOF Watt's linkage for a stable configuration where ϕ₁=210°, ϕ₂=90° along the path ϕ₂=90° (FIG. 3A). While the path is still stable as originally designed, there is a global minimum in PE_{T} at the desired configuration. We also designed for a stable configuration where ϕ₁=190°, ϕ₂=110°, along the path ϕ₂=300°−ϕ₁ (FIG. 3B).

### 2.3. Programming Sequential Stable Paths

Being able to design multiple paths that occur in sequence is critical for the design of multi-functional systems, where distinct motions involving different combinations of DOFs are needed to accomplish a task. We designed the two-DOF Watt's linkage to have continuous equilibrium along two paths: first, ϕ₁ increases from 170° to 195° while ϕ₂ remains constant at 105°, then ϕ₁ stays at 195° as ϕ₂ decreases to 80° (FIG. 2D). For this case, the ∇_{d} is divided into four regions:

$${∇}_{d} = \{ \begin{matrix}[ - 1 , - 1 ] , & {ϕ}_{1} < 195 , {ϕ}_{2} < 105 \\ [ 0 , 1 ] , & {ϕ}_{1} < 195 , {ϕ}_{2} > 105 \\ [ 1 , 0 ] , & {ϕ}_{1} > 195 , {ϕ}_{2} < 105 \\ [ 1 , - 1 ] , & {ϕ}_{1} > 195 , {ϕ}_{2} > 105\end{matrix} . \qquad ( 15 )$$

TABLE 1
Toolbox for various design scenarios.

| | Objective Function | Bounds | Constraints |
|---|---|---|---|
| Continuous Equilibrium | Eqn. 5 | Eqn. 6, | — |
| Stable Configuration | — | Eqn. 7 | — |
| Stable C.E. Path | Eqn. 9 | | Eqn. 11 |
| Seq. Stable C.E. Paths | Eqn. 9 | | Eqn. 11 |

While the potential energy along the two paths is not perfectly constant, the fluctuation is still reduced to 93% of the case with no springs. Actuating the structure along these paths will require less energy, and the system will remain stable, as ∇PE_{T} is aligned with ∇_{d}. This example focuses on designing two sequential paths for continuous equilibrium and does not specify the order or directionality of the paths, which can be controlled by adding stable states into the potential energy landscape as well as stable paths (as discussed in Section 3.3).

### 3. Design Examples

In this section, the design methodology through several examples are demonstrated. The first example expands upon the planar linkage results discussed in Section 3, where a model of an excavator as a linkage with a continuous equilibrium path. The next two examples are three-dimensional structures: a five-fold origami vertex and a pop-up kirigami dome. Origami and kirigami serve as design inspiration for many deployable and reconfigurable structures, and these examples demonstrate how such systems could be designed to have continuous equilibrium properties. These examples show how we can program a combination of stable states and stable paths. Table 1 summarizes the various design scenarios and which objective functions and constraints are used for each.

### 3.1. Excavator

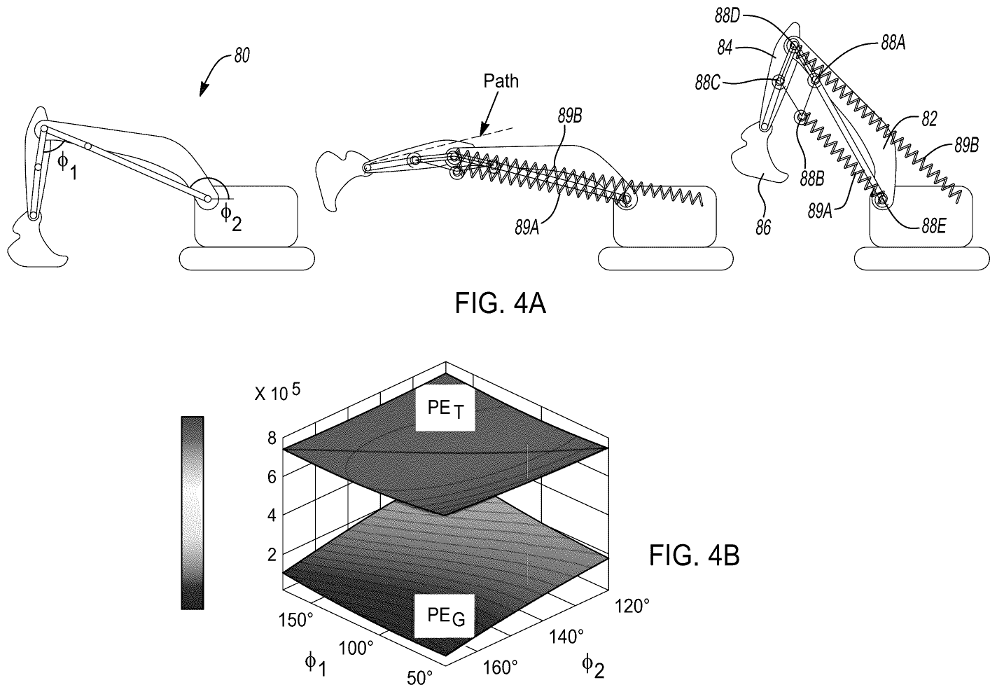

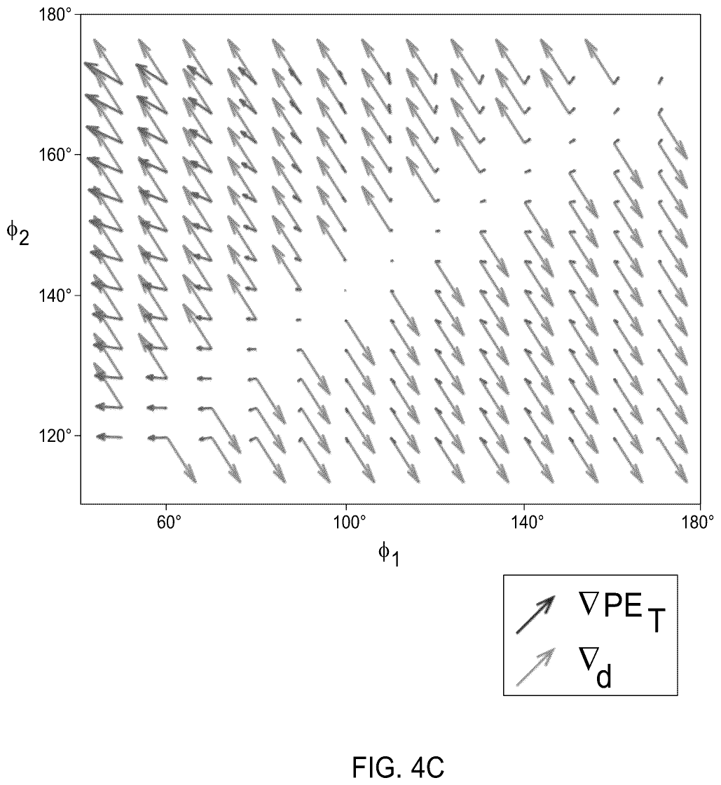

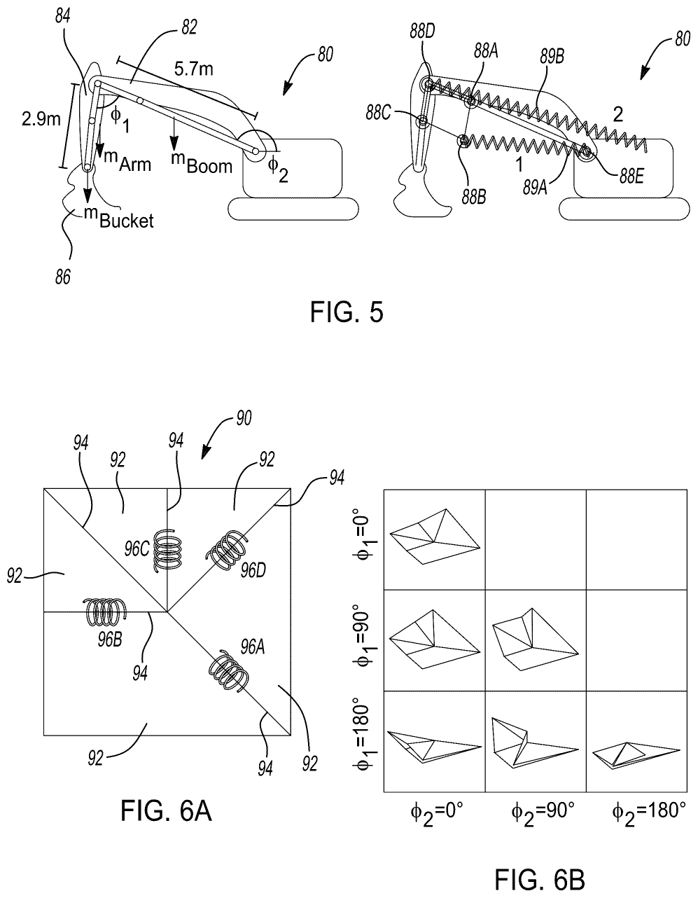

An excavator 80 (FIG. 4) is modeled as a two-DOF linkage (FIG. 5). A typical excavator has four DOFs, with hydraulic actuators used to move the boom 82, arm 84 and bucket 86. (A. J. Koivo, “Kinematics of Excavators (Backhoes) for Transferring Surface Material,” Journal of Aerospace Engineering, vol. 7, no. 1, pp. 17-32, 1994). We approximate the members of the excavator arm 80 as rigid links. The dimensions of the excavator linkage 80 are given in FIG. 5. The members 82, 84, 86 are modeled as rigid links with masses m_{Boom}=1710 kg and m_{Arm}=1300 kg, respectively. The bucket 86 is modeled as a lumped mass of m_{Bucket}=787 kg. The weights of the four bar linkage and springs are neglected. The springs 88A-88E used to achieve continuous equilibrium (labels shown in FIG. 5) have the following properties: α_{A}=0°, α_{B}=146°, α_{C}=360°, α_{D}=360°, α_{E}=13°, k_{A}=0 N-m/rad, k_{B}=24506 N-m/rad, k_{C}=0 N-m/rad, k_{D}=15733 N-m/rad, k_{E}=88464 N-m/rad, L₀₁=1.95 m, L₀₂=15 m, k₁=20759 N/m, k₂=4385 N/m.

The system is designed to have continuous equilibrium along the path ϕ₂=5/12* ϕ₁+99.17°, a typical motion that would be used for digging. Four internal torsional springs 88A-88D are used, one internal extensional spring 89A, one external torsional spring 88E, and one external extensional spring 89B are used in the system with optimized properties to minimize the fluctuation of PE_{T} along the path. The desired gradient field (used to formulate the stability constraint) is written as

$${∇}_{d} = \{ \begin{matrix}[ - 1 , 1 ] , & {ϕ}_{2} > {ϕ}_{1} + ° \\ [ 1 , - 1 ] , & {ϕ}_{2} < {ϕ}_{1} + °\end{matrix} . \qquad ( 16 )$$

The resulting PE_{T} surface is flat compared to PE_{G}, with a shallow valley along the desired path (FIG. 4B). Along the path, the fluctuation in PE_{T} is reduced by 66% from 22,152 N-m to 7,543 N-m. While the desired gradient is not matched well by ∇PE_{T}, the constraint is still satisfied, meaning that PE_{T} is in the range of directions from parallel to orthogonal to the path. While the path is not perfectly flat, the overall kinematic space is flattened, meaning reconfiguration along the path will require lower energy than the case without springs; additionally, if motions away from the path are desired, they can be reached with a small external force and the system will return to the path when the force is removed. The optimized spring properties are given above.

### 3.2. Five-fold Origami Vertex

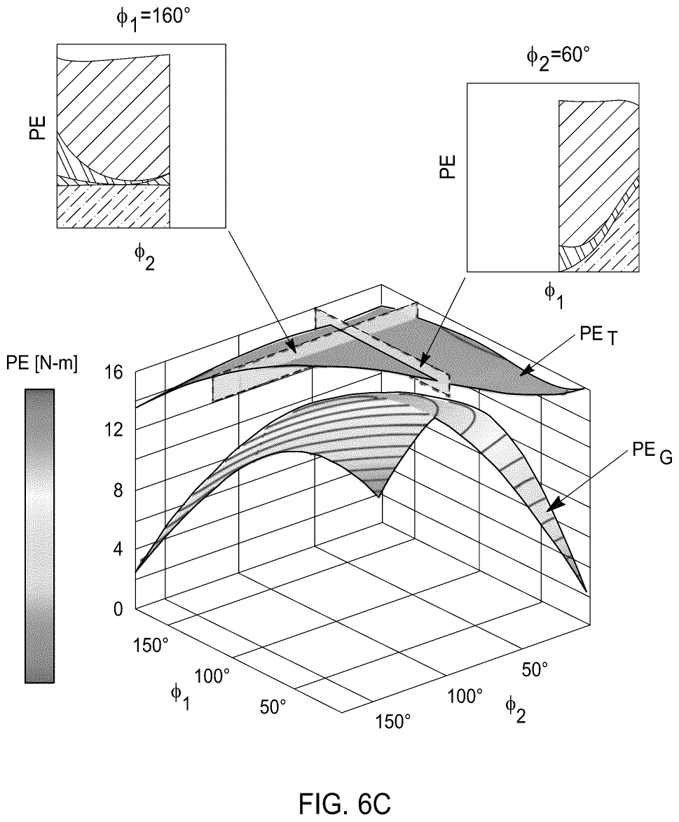

The five-fold origami vertex shown in FIG. 6 is a rigid-foldable origami structure 90 and has two DOFs defined by crease angles ϕ₁ and ϕ₂. We assume the structure consists of rigid panels 92 connected by frictionless rotational hinges 94. The potential energy for a three-dimensional system with n panels is PE_{G}=Σᵢⁿmᵢ*Aᵢ*g*hᵢ, where mᵢ is the mass distribution (units: N/m2), A, is the area, g=9.81 m/s², and hᵢ is the height of the center of mass of panel i. Certain combinations of ϕ₁ and ϕ₂ are not viable due to panel contact (FIG. 6B).

To design the five-fold vertex to have continuous equilibrium, four internal torsional springs 96A-96D are added along its crease lines, at locations four locations as shown. Adding a spring along the fifth crease does not improve results and thus is omitted from this design. The five-fold origami vertex is modeled as a 2 m-by-2 m sheet with uniform thickness equal to mm. We assume the material to have a uniform mass density of 1 kg/m². The optimized spring rest angles are α_{A}=273°, α_{B}=129°, α_{C}=89°, and α_{D}=62°; the optimized stiffnesses are k_{A}=7.99, k_{B}=1.60, k_{C}=0.00, and k_{D}=2.64 N-m/rad.

The resulting PE_{T} surface is nearly flat (FIG. 6C), and the fluctuation in potential energy is reduced by 90% from the case with no springs (PE_{G}).

### 3.3. Pop-up Kirigami Dome

Kirigami sheets cut into hexagonal panels 102 and trapezoidal panels 104 can be used to create a pop-up dome 100 with high stiffness (M. Redoutey, A. Roy, and E. T. Filipov, “Pop-up kirigami for stiff, dome-like structures,” International Journal of Solids and Structures, vol. 229, pp. 1-13, 2021). the kirigami dome structure 100 includes a plurality of interconnected multi-panel cells 101. The plurality of interconnected multi-panel cells 101 each include a hexagonal panel 102 and a plurality of trapezoidal panels 104. The plurality of interconnected multi-panel cells 101 are connected to adjacent multi-panel cells 101 by a hinge 112. Each multi-panel cell 101 has an extensional spring 106 extending across the multi-panel cells 101. A torsion spring 110 is provide on the hinge 112 between adjacent multi-panel cells 101. The plurality of interconnected multi-panel cells each include a top portion 101a connected to an identical bottom portion 101b at perimeter edges thereof. The outer perimeter edges of the top portion 101a are hingedly connected to the outer perimeter edges of the bottom portion 101b. Extensional springs 108 extend between the top portion 101a and the bottom portion 101b.

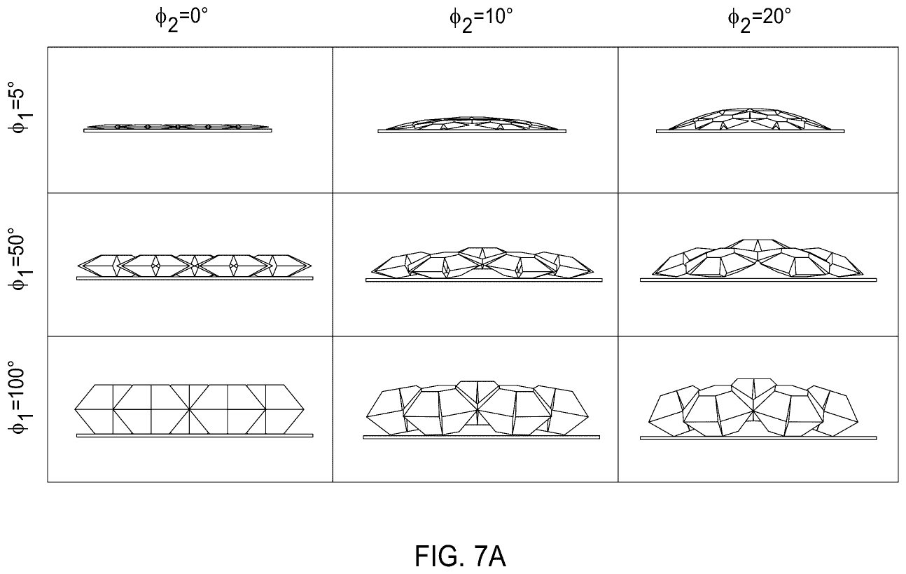

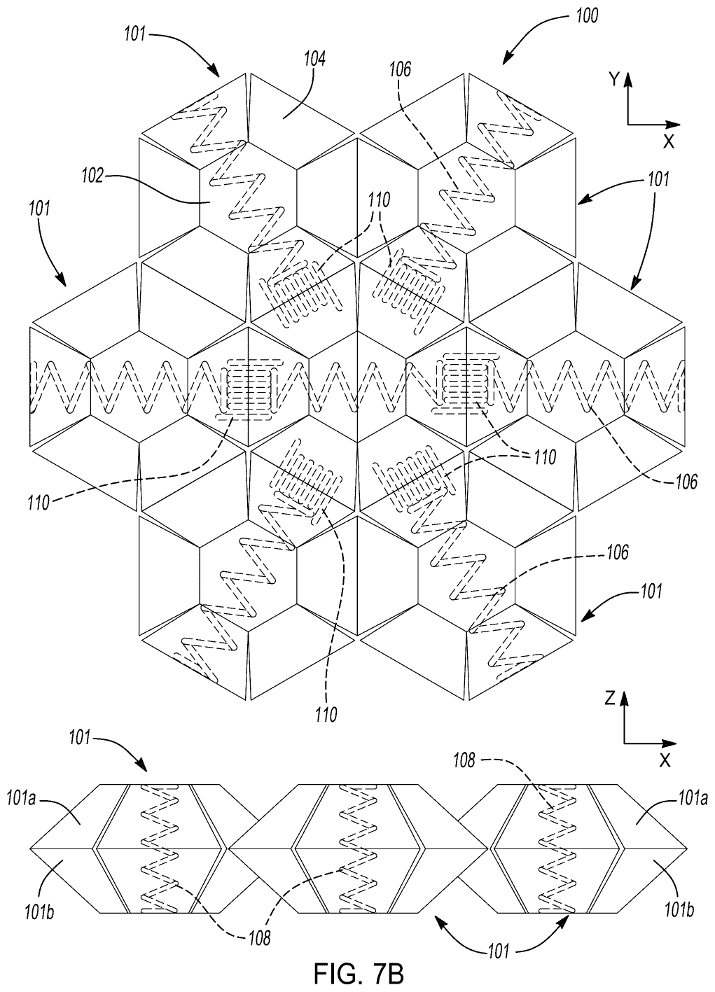

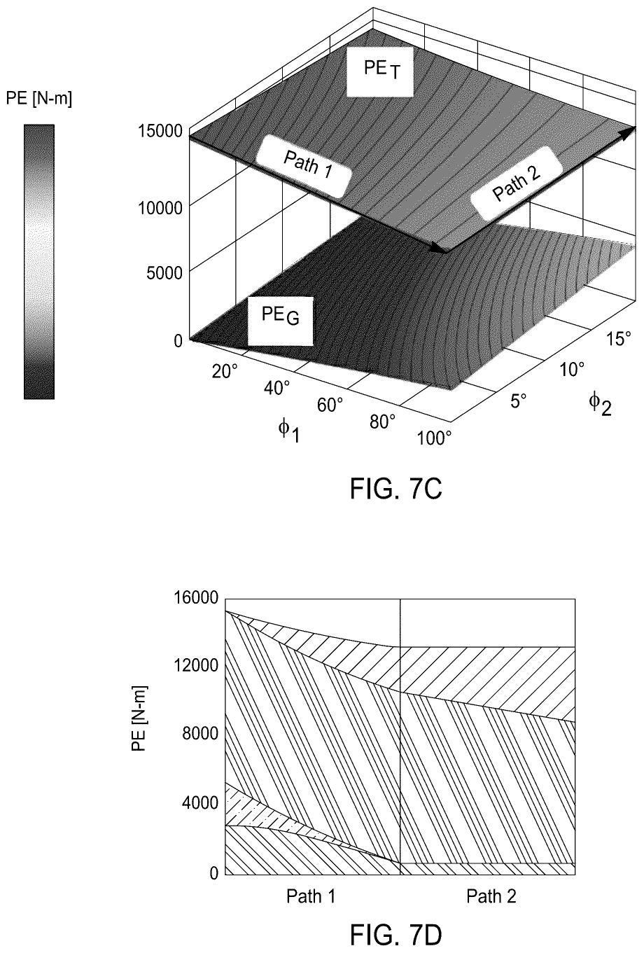

The dome structure 100 has two DOFs: assembly from a flat sheet (defined by ϕ₁) and a dome-forming motion (ϕ₂) (FIG. 7A). The dome 100 exhibits high stiffness when it is fully assembled and then deformed into a shape with double curvature. We use extensional springs placed within the hexagonal cells and torsional springs placed between them (FIG. 7B) to program the desired motion of full assembly and then dome-forming. Since the assembly step must be completed before the dome-forming step begins, we program a stable state at the end of the assembly path. The dome-forming path is then designed to have continuous equilibrium. To enforce that the dome-forming path will be stable, we used a constraint that requires ∇PE_{T} to be aligned with a desired gradient.

$${∇}_{d} = \{ \begin{matrix}[ - 1 , 0 ] , & {ϕ}_{1} < 100 ° .\end{matrix} \qquad ( 17 )$$

This constraint also requires there to be a local potential energy minimum at the end of path 1. To ensure that the local minimum is a stable state, we introduce an additional constraint to control the concavity of PE_{T} along path 1.

$$- \frac{{d}^{2} {PE}_{{T}_{path 1}}}{d {ϕ}_{1}^{2}} \leq 0 \qquad ( 18 )$$

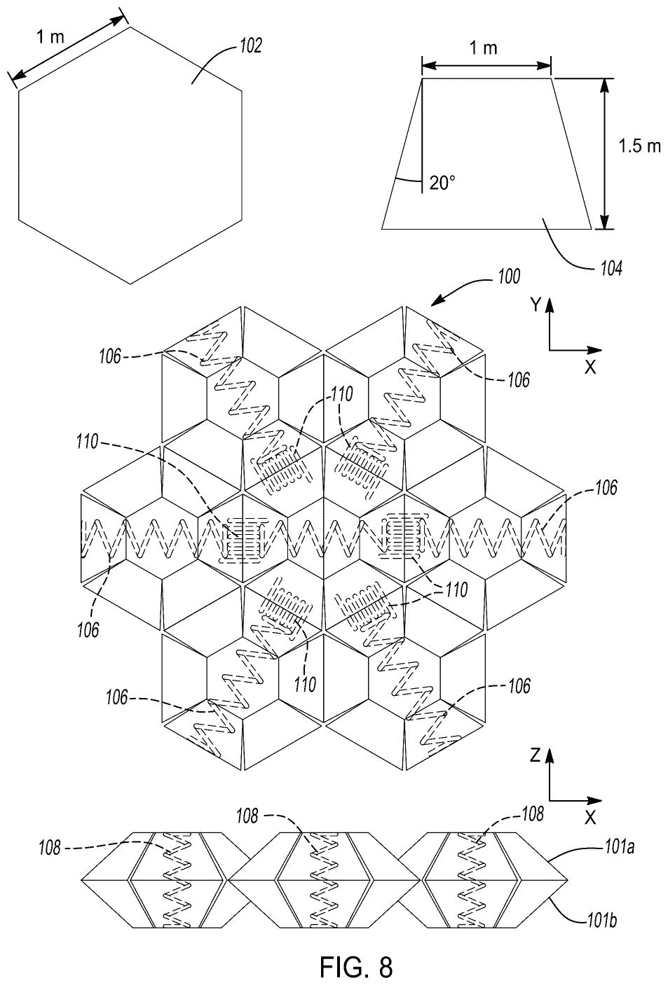

FIG. 7C shows the potential energy of the system. Along the path, there is a potential energy valley at the end of the assembly step (FIG. 7D). The fluctuation in potential energy along the dome-forming step has been minimized; without springs, the fluctuation is 519 N-m and with springs 106, 108, 110 it is 22.3 N-m, a 95.7% reduction. Typically, external forces are required to keep the structure 100 in its dome-like shape; with the dome-forming motion being in continuous equilibrium, lower forces would be required. The dimensions of the hexagonal panels 102 and trapezoidal panels 104 used to construct the pop-up kirigami dome 100 are shown in FIG. 8. We assume that the panels 102, 104 are made from a material with uniform thickness and mass density equal to 1 kg/m. The optimized spring properties are L₀₁=2.65 m, k₁=197 N/m; L₀₂=2.3 m, k₂=149 N/m; α₃=3.68, k₃=200 N-m/rad.

The present disclosure presents a method for programming continuous equilibrium motions in multi-DOF systems. Using optimization, we can compute spring properties that minimize the fluctuation in potential energy throughout the kinematic space or along a desired path. The method can be used to design systems with stable paths, stable configurations, and sequential stable paths. The method is demonstrated on one-, two-, and three-DOF Watt's linkages designed to have continuous equilibrium throughout their entire kinematic space. The two-DOF system is used to demonstrate the capability to program stable paths and configurations. An optimization constraint is formulated that is used to ensure the stability of a path by aligning the gradient of the potential energy space with a desired gradient field. With this constraint, small perturbations away from the path will not cause the system to deviate from the desired path and collapse. The examples shown in Section 3 demonstrate how the method can be used to design practical two- and three-dimensional systems. The concepts of the present disclosures provide a foundation for the design of multi-DOF reconfigurable structures that require significantly less energy for stable deployment and reconfiguration. Using the present design method, designers can take advantage of the complex, functional motions that multi-DOF systems provide while maintaining stability and avoiding collapse. Programming a set of stable paths and configurations can help limit the infinite possibilities for motion and result in a system that gravitates back to a desired path without external forcing. Programming of continuous equilibrium can greatly improve the design, fabrication, and operation of multi-DOF reconfigurable structures by ensuring efficient actuation, desired motions, and stability under gravity. The principles presented here are scale-independent and relevant to multiple disciplines with potential applications in robotics, architecture, consumer goods, vehicle systems, and more.

### 4. Methods

The kinematics of the Watt's linkage variations were determined using geometric relationships. The boundary of the five-fold origami vertex kinematic space (that exists due to panel contact) was determined using the SWOMPS software package (Y. Zhu and E. T. Filipov, “Rapid Multi-Physics Simulation for Electro-Thermal Origami Systems,” Heterocyclic Communications, 2021). The kinematics of the pop-up kirigami dome were computed using geometric relationships and the MERLIN2 bar and hinge model (K. Liu and G. H. Paulino, “Highly efficient nonlinear structural analysis of origami assemblages using the MERLIN2 software,” Origami, vol. 7, pp. 1167-1182, 2018). The optimization was conducted using fmincon in MATLAB, which finds the minimum of a constrained nonlinear multi-variable function. The objective functions, bounds on design variables, and constraints used for each design scenario are given in Table 1. To aid in obtaining a feasible result, we use the GlobalSearch function to determine the starting point of the optimization. GlobalSearch repeats the optimization from various starting points, evaluating their performance and adapting the simulation accordingly, until the optimization converges on the lowest feasible objective function value. The constraint given in Equation 11 was applied using nonlcon in MATLAB.

The table below provides the optimized spring properties for design cases where the fluctuation in potential energy is minimized across the entire kinematic space (FIG. 1) for the one-, two-, and three-DOF Watt's linkage.

TABLE A

| | Rest Angle | | | | | | Stiffness [N-m/rad] | | | | | |
|---|---|---|---|---|---|---|---|---|---|---|---|---|
| | α_{A} | α_{B} | α_{C} | α_{D} | α_{E} | α_{F} | k_{A} | k_{B} | k_{C} | k_{D} | k_{E} | k_{F} |
| One-DOF | 108° | 81° | 184° | 26° | | | 4.29 | 0.51 | 3.55 | 3.08 | | |
| Two-DOF | 157° | 197° | 166° | 196° | 116° | | 35.3 | 0 | 26.5 | 0 | 23.6 | |
| Three-DOF | 0° | 142° | 360° | 197° | 0° | 159° | 12.0 | 0 | 8.21 | 0 | 7.64 | 12.8 |

The table below contains the spring properties for design cases where the fluctuation in potential energy of the two-DOF Watt's linkage is minimized along a stable, continuous equilibrium path (FIG. 2).

TABLE B

| | Rest Position | | | | | | | Stiffness | | | | | | |
|---|---|---|---|---|---|---|---|---|---|---|---|---|---|---|
| | Angle | | | | | Rest [m] | | [N-m/rad] | | | | | [N/m] | |
| Path | α_{A} | α_{B} | α_{C} | α_{D} | α_{E} | L01 | L02 | k_{A} | k_{B} | k_{C} | k_{D} | k_{E} | k₁ | k₂ |
| ϕ₂ = 90° | 0° | 0° | 199° | 0° | 94° | | | 0 | 6.3 | 5.9 | 8.7 | 200 | | |
| ϕ₂ = 300° − ϕ₁ | 0° | 201° | 266° | 180° | 93° | | | 11.1 | 5.9 | 6.2 | 20.9 | 13.8 | | |
| ϕ₂ = (212° − | 21.2° | 77.5° | | | | 0.84 | 1.4 | 26.7 | 209 | | | | 34.3 | 49.9 |
| ϕ₁)² + 86° | | | | | | | | | | | | | | |
| ϕ₂ = 105°, | 0z° | 360° | 136° | 235° | 65° | | | 20.8 | 6.5 | 14.6 | 0 | 24.5 | | |
| ϕ₁ = 195° | | | | | | | | | | | | | | |

This section contains the spring rest angles for the additional set of springs used to program a stable configuration along a stable path for the two-DOF Watt's linkage (FIG. 3). This set of springs is added to the two-DOF Watt's linkage that has already been optimized to have a stable path using the spring properties given in Table A. The potential energy stored in the additional set of springs is then superimposed on the designed system to add the stable configuration. The stiffness of the additional springs can be any positive value and affects the steepness of the potential energy minimum. The results shown in FIG. 3 are for springs with a stiffness of 20 N-m/rad.

TABLE C

| ϕ₂ = 90° | Rest Angle | | | | | |
|---|---|---|---|---|---|---|
| Path | Configuration | α_{A} | α_{B} | α_{C} | α_{D} | α_{E} |
| ϕ₂ = 90° | ϕ₁ = 210°, | 210° | 128° | 77.5° | 200° | 90° |
| | ϕ₂ = 90° | | | | | |
| ϕ₂ = 300° − ϕ₁ | ϕ₁ = 190°, | 190° | 105° | 70.5° | 205° | 110° |
| | ϕ₂ = 110° | | | | | |

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of configuring a continuous equilibrium system comprising:
providing a plurality of structural members pivotally coupled together at a plurality of pivot joints and reconfigurable at least in response to gravity;
determining a potential energy of the plurality of structural members as a result of gravity;
calculating spring properties for springs located at one or more of the plurality of pivot joints to offset gravity that is operable to maintain a generally constant potential energy of the system irrespective of orientation in three-dimensional space; and
mounting the springs to the one or more plurality of pivot joints according to the calculated spring properties.

2. The method of configuring a continuous equilibrium system according to claim 1, wherein the system is an excavator arm having a boom, an arm and a bucket.

3. The method of configuring a continuous equilibrium system according to claim 2, wherein the springs include a first torsion spring connected between the arm and the bucket.

4. The method of configuring a continuous equilibrium system according to claim 3, wherein the springs include a second torsion spring connected between the boom and the arm.

5. The method of configuring a continuous equilibrium system according to claim 2, where the springs are torsion springs including a first torsion spring connected between the boom and an excavator body.

6. The method of configuring a continuous equilibrium system according to claim 1, wherein the system includes a plurality of panels connected by rotational hinges.

7. The method of configuring a continuous equilibrium system according to claim 6, wherein the springs are torsion springs connected to adjacent panels about an axis of the respective hinges.

8. The method of configuring a continuous equilibrium system according to claim 1, wherein the system is a kirigami structure.

9. The method of configuring a continuous equilibrium system according to claim 8, wherein the kirigami structure includes a plurality of interconnected multi-panel cells.

10. The method of configuring a continuous equilibrium system according to claim 9, wherein the plurality of interconnected multi-panel cells each include a hexagonal panel and a plurality of trapezoidal panels.

11. The method of configuring a continuous equilibrium system according to claim 9, wherein the plurality of interconnected multi-panel cells are connected to adjacent multi-panel cells by a hinge.

12. The method of configuring a continuous equilibrium system according to claim 9, further comprising each multi-panel cell having a spring extending across the multi-panel cell.

13. The method of configuring a continuous equilibrium system according to claim 12, further comprising a torsion spring on the hinge between adjacent multi-panel cells.

14. The method of configuring a continuous equilibrium system according to claim 9, wherein the plurality of interconnected multi-panel cells each include a top portion connected to an identical bottom portion at perimeter edges thereof.

15. The method of configuring a continuous equilibrium system according to claim 14, further comprising an extension spring connected between the top portion and the bottom portion of each of the plurality of interconnected multi-panel cells.

16. The method of configuring a continuous equilibrium system according to claim 1, wherein the system is an arm structure of a mechanical device.

17. The method of configuring a continuous equilibrium system according to claim 1, wherein the system is a panel system of an architectural device.

18. The method of configuring a continuous equilibrium system according to claim 1, wherein the system is a mechanical arm having multiple sections and an actuator connected between adjacent arm sections.

19. The method of configuring a continuous equilibrium system according to claim 18, wherein the actuator is one of a hydraulic, pneumatic, servo-electric and electro-mechanical actuator.
